(19) United States
(12) Patent Application Publication
(10) Pub. No.: US 2014/0233030 A1
(43) Pub. Date: Aug. 21, 2014

(54) SPECTRAL IMAGING DEVICE ADJUSTMENT METHOD AND SPECTRAL IMAGING SYSTEM

(71) Applicant: Sumitomo Electric Industries, Ltd., Osaka-shi (JP)

(72) Inventors: Masato Tanaka, Yokohama-shi (JP); Ichiro Sogawa, Yokohama-shi (JP)

(73) Assignee: SUMITOMO ELECTRIC INDUSTRIES, LTD., Osaka-shi (JP)

(21) Appl. No.: 14/346,948

(22) PCT Filed: May 23, 2013
(86) PCT No.: PCT/JP2013/064306

§ 371 Date: Mar. 24, 2014

(30) Foreign Application Priority Data
May 25, 2012 (JP) 2012-119377

(51) Int. Cl. G01J 3/28

(52) U.S. Cl. CPC G01J 3/2823
USPC 356/328

(57) ABSTRACT

A method of adjusting a spectroscopic imaging device is provided with which a relative arrangement relationship among components can be easily adjusted in the spectroscopic imaging device. A spectroscopic imaging device 30 includes a collimating lens 32, a diffraction grating 33, a condensing lens 34, an array light receiving unit 35, and adjustment means for adjusting a relative arrangement relationship among these components. An etalon filter is disposed on an optical path of light inputted to the collimating lens 32 and the relative arrangement relationship among the components is adjusted so that the focal point of light of each wavelength condensed by the condensing lens 34 is positioned on a predetermined line of the array light receiving unit 35.

### TECHNICAL FIELD

The present invention relates to a spectroscopic imaging device adjustment method and a spectroscopic imaging system.

### BACKGROUND ART

A spectroscopic imaging device includes a collimating lens that collimates input light, a diffraction grating that receives light collimated by the collimating lens and outputs the light in different directions in accordance with the wavelength of the light, a condensing lens that condenses light outputted from the diffraction grating at different positions in accordance with the wavelength of the light, and an array light receiving unit. The array light receiving unit includes a plurality of light receiving sensors that are arranged in an array along a predetermined line and receives light condensed by the condensing lens by using one of the light receiving sensors thereof. A spectroscopic imaging device can measure a spectrum of input light.

A spectroscopic imaging device can analyze components of a substance by measuring an absorption spectrum of the substance, for example. Furthermore, a spectroscopic imaging device can obtain the thickness or relative distance of an object by measuring a spectrum of interference fringes formed by object beams and reference beams.

In order to measure a spectrum of light with high precision using a spectroscopic imaging device, the wavelength of light received by each of plurality of light receiving sensors of an array light receiving unit needs to be known. Japanese Unexamined Patent Application Publication No. 61-56922 (Patent Literature 1) and Mircea Mujat, et al, “Autocalibration of spectral-domain optical coherence tomography spectrometers for in vivo quantitative retinal nerve fiber layer birefringence determination,” Journal of Biomedical Optics 12(4), 041205, July/August 2007 (Non Patent Literature 1) describe a method of associating each light receiving sensor of an array light receiving unit in a spectroscopic imaging device with a wavelength.

In order to measure a spectrum of light with a high wavelength resolution using a spectroscopic imaging device, the focal point of light of each wavelength condensed by a condensing lens needs to be positioned on the predetermined line described above. However, a relative arrangement relationship among components of a spectroscopic imaging device may be altered due to an external impact, looseness occurring over time, or the like. In such a case, when the focal point of light of each wavelength condensed by a condensing lens is shifted away from the predetermined line, the wavelength resolution or detection efficiency relating to a measured spectrum decreases. With the method described in Patent Literature 1 and Non Patent Literature 1, the problem described above cannot be addressed.

### SUMMARY OF INVENTION

### Technical Problem

It is an object of the present invention to provide a spectroscopic imaging device adjustment method with which a relative arrangement relationship among components can be easily adjusted in a spectroscopic imaging device and to provide a spectroscopic imaging system to which such a spectroscopic imaging device adjustment method is applicable.

### Solution to Problem

To address the problem, there is provided a method of adjusting a spectroscopic imaging device including a collimating lens that collimates input light, a diffraction grating that receives light collimated by the collimating lens and outputs the light in different directions in accordance with a wavelength of the light, a condensing lens that condenses light outputted from the diffraction grating at different positions in accordance with a wavelength of the light, and an array light receiving unit that includes a plurality of light receiving sensors that are arranged in an array along a predetermined line (straight line) and receives light condensed by the condensing lens by using one of the light receiving sensors. In the method of adjusting a spectroscopic imaging device, an etalon filter is disposed on an optical path of light inputted to the collimating lens, and a relative arrangement relationship among the collimating lens, the diffraction grating, the condensing lens, and the array light receiving unit is adjusted so that, in a state where light that has passed through the etalon filter is inputted to the spectroscopic imaging device, a focal point of light of each wavelength condensed by the condensing lens is positioned on the predetermined line.

In the method of adjusting a spectroscopic imaging device of the present invention, a full width at half maximum (FWHM) of a transmission spectrum of the etalon filter may be smaller than a wavelength resolution of the array light receiving unit. Furthermore, a free spectral range (FSR) of the transmission spectrum of the etalon filter may be ten times or more the wavelength resolution of the array light receiving unit, and a wavelength bandwidth of light received by the array light receiving unit may be ten times or more the FSR of the transmission spectrum of the etalon filter.

In the method of adjusting a spectroscopic imaging device of the present invention, a Fourier transform may be performed on an intensity distribution of light received by the array light receiving unit and a spatial frequency distribution may be obtained, and the relative arrangement relationship among the collimating lens, the diffraction grating, the condensing lens, and the array light receiving unit may be adjusted so that a value of a high-frequency component in the spatial frequency distribution is large. In this case, each of the light receiving sensors in the array light receiving unit may be associated with a wavelength so that a relationship between a phase of a fundamental wave component in the spatial frequency distribution obtained by performing a Fourier transform and a wave number assigned to each of the light receiving sensors in the array light receiving unit is linear.

In the method of adjusting a spectroscopic imaging device of the present invention, the relative arrangement relationship among the collimating lens, the diffraction grating, the condensing lens, and the array light receiving unit may be adjusted so that the sum total of α (α>1)-th power values of respective output values of the plurality of light receiving sensors of the array light receiving unit is large.

As another aspect of the present invention, there is provided a spectroscopic imaging system including a collimating lens that collimates input light, a diffraction grating that receives light collimated by the collimating lens and outputs the light in different directions in accordance with a wavelength of the light, a condensing lens that condenses light outputted from the diffraction grating at different positions in accordance with a wavelength of the light, an array light receiving unit that receives light condensed by the condensing lens by using one light receiving sensor among a plurality of light receiving sensors that are arranged in an array along a predetermined line, an etalon filter that is provided so as to be disposed on or removed from an optical path of light inputted to the collimating lens as desired, and adjustment means for adjusting a relative arrangement relationship among the collimating lens, the diffraction grating, the condensing lens, and the array light receiving unit.

In the spectroscopic imaging system of the present invention, an FWHM of a transmission spectrum of the etalon filter may be smaller than a wavelength resolution of the array light receiving unit. Furthermore, an FSR of the transmission spectrum of the etalon filter may be ten times or more the wavelength resolution of the array light receiving unit, and a wavelength bandwidth of light received by the array light receiving unit may be ten times or more the FSR of the transmission spectrum of the etalon filter.

### Advantageous Effects of Invention

According to the present invention, a relative arrangement relationship among components can be easily adjusted in a spectroscopic imaging device.

### BRIEF DESCRIPTION OF DRAWINGS

FIG. 1 is a schematic diagram illustrating an embodiment of a spectroscopic imaging system of the present invention.

FIG. 2 is a schematic diagram of a spectroscopic imaging device in the embodiment of the spectroscopic imaging system in FIG. 1.

FIG. 3 includes graphs each illustrating an intensity distribution of light received by an array light receiving unit.

FIG. 4 includes graphs each illustrating a spatial frequency distribution obtained by performing a Fourier transform on each of the light intensity distributions in FIG. 3.

### DESCRIPTION OF EMBODIMENT

An embodiment of the present invention is described below with reference to the drawings. The drawings are provided for illustration and do not intend to limit the scope of the invention. In the drawings, the identical numerals denote the same elements so as to avoid redundant description. The ratios of dimensions in the drawings are not necessarily exact.

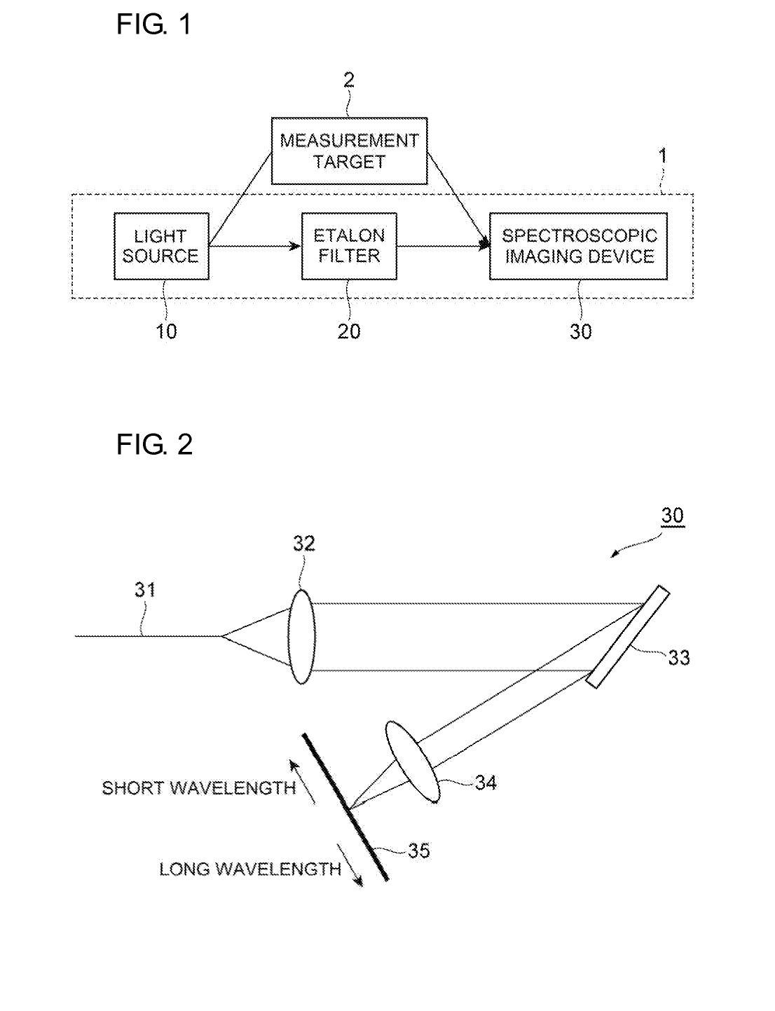

FIG. 1 is a schematic diagram illustrating a spectroscopic imaging system 1, which is an embodiment of the present invention. The spectroscopic imaging system 1 includes a light source 10, an etalon filter 20, and a spectroscopic imaging device 30 and can measure an absorption spectrum or an interference spectrum of a measurement target 2. The measurement target 2 is, in the case of measuring an absorption spectrum, a transmitting optical system including two lenses opposed to each other and a measurement object disposed between the two lenses and is, in the case of measuring an interference spectrum, a Michelson interferometer, a Mach-Zehnder interferometer, or the like, for example.

The etalon filter 20 and the measurement target 2 are each provided so as to be disposed on or removed from an optical path extending from the light source 10 to the spectroscopic imaging device 30 as desired. The etalon filter 20 and the measurement target 2 may be each disposed on or removed from the optical path as desired by moving the etalon filter 20 or the measurement target 2 or by switching the optical path using an optical switch, an optical splitter, an optical coupler, a shutter, or the like.

The light source 10 can output wideband continuous light. As the light source 10, a supercontinuum (SC) light source, an amplified spontaneous emission (ASE) light source, a super luminescent diode (SLD), or the like may be preferably used, for example. The etalon filter 20 is formed of two reflecting surfaces each having a high reflectance, which are opposed to each other at a certain distance. It is preferable that the etalon filter 20 have high finesse.

In the etalon filter 20, let R be the reflectance of each of the two reflecting surfaces, d be the effective optical path length (geometrical length×refractive index) between the two reflecting surfaces, θ be the inclination, and λ be the wavelength. It is assumed that absorption of light in the etalon filter 20 is ignored. In this case, the transmittance T(λ) of the etalon filter 20 is expressed by Eq. (1). The free spectral range (FSR) of the etalon filter 20 is expressed by Eq. (2). The finesse of the etalon filter 20 is expressed by Eq. (3). The peak width, that is, the full width at half maximum (FWHM) of a transmission spectrum of the etalon filter 20 is expressed by Eq. (4).

T(λ)=1/{1+4R/(1−R)²*sin²(2πd sin θ/λ)} (1)

FSR=λ²/2d (2)

Finesse=πR^{1/2}/(1−R) (3)

FWHM=FSR/Finesse (4)

For example, in the etalon filter 20, it is assumed that the reflectance R of each of the two reflecting surfaces is 95% and the effective optical path length between the two reflecting surfaces is 0.3 mm. In this case, at the wavelength is 1300 nm, the FSR of the etalon filter 20 is 2.8 nm, the finesse of the etalon filter 20 is 61.2, and the peak width or the FWHM of the etalon filter 20 is 0.06 nm.

The transmittance T(λ) of the etalon filter 20 has a characteristic such that peaks each having a high transmittance periodically appear. In the case where absorption of light does not occur in the etalon filter 20, the peak value of the transmittance is 1 theoretically. In the case where the reflectance R of each of the two reflecting surfaces is close to 1, the peak width or the FWHM of a transmission spectrum is narrow. In this embodiment, it is preferable that the reflectance R of each of the two reflecting surfaces be close to 1 (for example, 90% or more).

The spectroscopic imaging device 30 measures a spectrum of light reaching the spectroscopic imaging device 30 from the measurement target 2 or the etalon filter 20. FIG. 2 is a schematic diagram of the spectroscopic imaging device 30 in the spectroscopic imaging system 1. The spectroscopic imaging device 30 includes an optical fiber 31, a collimating lens 32, a diffraction grating 33, a condensing lens 34, and an array light receiving unit 35. The spectroscopic imaging device 30 further includes adjustment means for adjusting a relative arrangement relationship among the collimating lens 32, the diffraction grating 33, the condensing lens 34, and the array light receiving unit 35.

The optical fiber 31 guides light outputted from the measurement target 2 or the etalon filter 20 and outputs the light from an end face thereof. The collimating lens 32 collimates light outputted from the end face of the optical fiber 31. The diffraction grating 33 receives light collimated by the collimating lens 32 and outputs the light in different directions in accordance with the wavelength of the light. The condensing lens 34 condenses light outputted from the diffraction grating 33 at different positions in accordance with the wavelength of the light. The array light receiving unit 35 includes a plurality of light receiving sensors that are arranged in an array along a predetermined line at a constant pitch and receives light condensed by the condensing lens 34.

The adjustment means for adjusting the relative arrangement relationship includes means for translating each of the collimating lens 32, the diffraction grating 33, the condensing lens 34, and the array light receiving unit 35 and means for changing the orientations of these components. Specifically, the adjustment means includes means for adjusting the position of the collimating lens 32 and means for adjusting the distance between the condensing lens 34 and the array light receiving unit 35. As the adjustment means described above, a movable stage or the like is used.

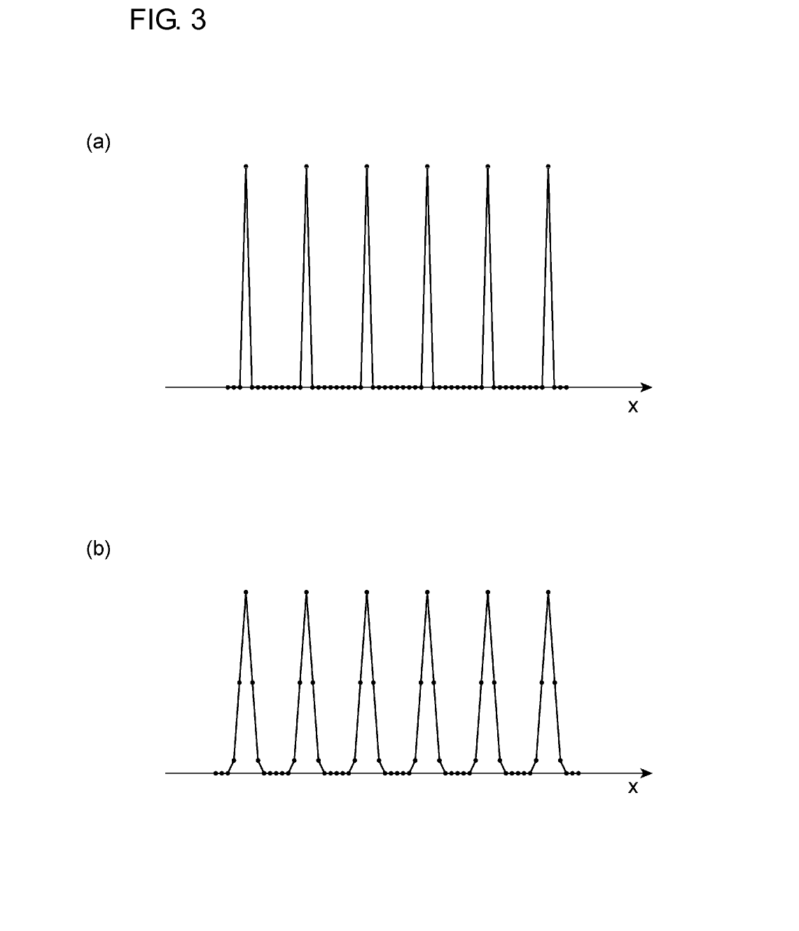

When light outputted from the etalon filter 20, the reflectance R of each of the two reflecting surfaces thereof being close to 1, is received by the spectroscopic imaging device 30, light of each wavelength dispersed by the diffraction grating 33 is condensed in a corresponding light receiving sensor among the plurality of light receiving sensors of the array light receiving unit 35, in the case of a best adjustment condition. In this case, as illustrated in the region of FIG. 3(a), a light intensity distribution observed on the predetermined line along which the plurality of light receiving sensors are arranged in an array in the array light receiving unit 35 has a pattern in which a plurality of peaks each having a narrow width periodically appear.

On the other hand, in the case where adjustment of the spectroscopic imaging device 30 is not in the best condition, light of each wavelength dispersed by the diffraction grating 33 is received not only by a corresponding light receiving sensor among the plurality of light receiving sensors of the array light receiving unit 35 but also by light receiving sensors in the vicinity of the corresponding light receiving sensor. In this case, as illustrated in the region of FIG. 3(b), in a light intensity distribution observed on the predetermined line along which the plurality of light receiving sensors are arranged in an array in the array light receiving unit 35, the width of each peak is wide.

Therefore, the relative arrangement relationship among the collimating lens 32, the diffraction grating 33, the condensing lens 34, and the array light receiving unit 35 may be adjusted so that the width of each peak is narrow as illustrated in the region of FIG. 3(a) in an intensity distribution of light received by the array light receiving unit 35. The width of the peak in the best adjustment condition could be narrower than the diffraction limit. By performing adjustment as described above, the focal point of light of each wavelength condensed by the condensing lens 34 is positioned on the predetermined line along which the plurality of light receiving sensors are arranged in an array in the array light receiving unit 35, which is the best condition.

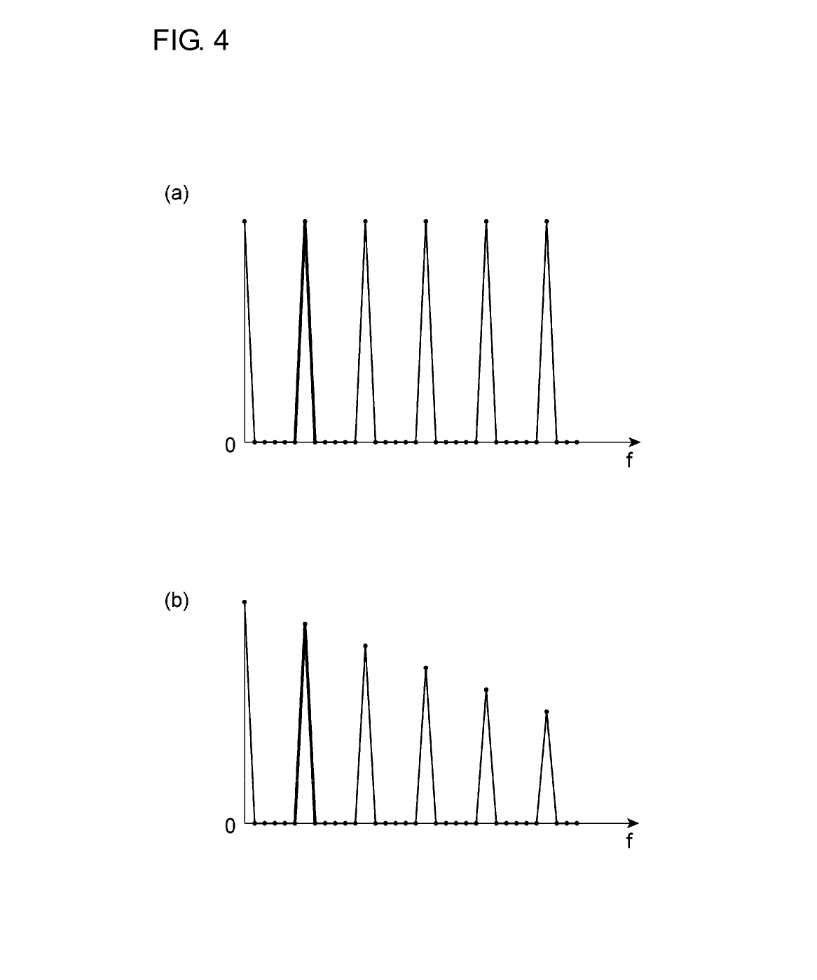

In the case where the spectroscopic imaging device 30 is in the best adjustment condition, when a discrete Fourier transform is performed on the light intensity distribution illustrated in the region of FIG. 3(a), a spatial frequency distribution as illustrated in the region of FIG. 4(a) is obtained. In the spatial frequency distribution in this case, a plurality of peaks periodically appear and the peak value of a fundamental wave component (component drawn with a thick line in FIG. 4(a)) is substantially equal to the peak values of high-frequency components.

On the other hand, in the case where the spectroscopic imaging device 30 is not in the best adjustment condition, when a discrete Fourier transform is performed on the light intensity distribution illustrated in the region of FIG. 3(b), a spatial frequency distribution as illustrated in the region of FIG. 4(b) is obtained. In the spatial frequency distribution in this case, a plurality of peaks periodically appear, the peak values of high-frequency components are smaller than the peak value of a fundamental wave component (component drawn with a thick line in FIG. 4(b)), and the peak value becomes smaller as the frequency increases.

Therefore, the relative arrangement relationship among the components that constitute the spectroscopic imaging device may be adjusted so that the values of high-frequency components in a spatial frequency distribution are large (that is, the values of high-frequency components are as illustrated in the region of FIG. 4(a)), the spatial frequency distribution being obtained by performing a Fourier transform on an intensity distribution of light received by the array light receiving unit 35. Also by performing adjustment as described above, the focal point of light of each wavelength condensed by the condensing lens 34 is positioned on the predetermined line along which the plurality of light receiving sensors are arranged in an array in the array light receiving unit 35, which is the best condition.

In this case, a correspondence between each of the light receiving sensors of the array light receiving unit 35 and a wavelength can be modified on the basis of a phase of a complex function obtained by extracting a fundamental wave component in a spatial frequency distribution that is obtained by performing a Fourier transform, using a band-pass filter

$${H}_{sq} ( ω , {ω}_{0} ) = \{ \begin{matrix}1 & \vert ω - {ω}_{0} \vert < Δω \\ 0 & other\end{matrix} \qquad [ Equation 1 ]$$

and performing an inverse Fourier transform on the extracted fundamental wave component. More specifically, (1) an initial value of the wave number is assigned to each of the plurality of light receiving sensors that are arranged at a constant pitch in the array light receiving unit 35, (2) a nonlinear component between a phase of a complex function obtained by the filtering described above and the initial value of the wave number described above is extracted, and (3) the assignment of the wave number to each of the plurality of light receiving sensors is modified so that the nonlinear component is small.

Furthermore, the relative arrangement relationship among the collimating lens 32, the diffraction grating 33, the condensing lens 34, and the array light receiving unit 35 may be adjusted so that the sum total of α (α>1)-th power values of respective output values of the plurality of light receiving sensors of the array light receiving unit 35 is large. Also by performing adjustment as described above, the focal point of light of each wavelength condensed by the condensing lens 34 is positioned on the predetermined line along which the plurality of light receiving sensors are arranged in an array in the array light receiving unit 35, which is the best condition.

In order to effectively perform the adjustment described above, the FSR of the etalon filter 20 needs to be larger than the wavelength resolution (a difference between wavelengths respectively corresponding to two light receiving sensors adjacent to each other) of the array light receiving unit 35 and smaller than the wavelength bandwidth (a difference between wavelengths respectively corresponding to a light receiving sensor positioned on one end and a light receiving sensor positioned on the other end) of the array light receiving unit 35. Furthermore, it is preferable that the peak width or the FWHM of a transmission spectrum of the etalon filter 20 be smaller than the wavelength resolution of the array light receiving unit 35.

For example, it is assumed that the number of light receiving sensors in the array light receiving unit 35 is 256 and the wavelength resolution of the array light receiving unit 35 is 0.2 nm. The etalon filter 20 is formed as in the example described above. Furthermore, it is assumed that the center wavelength is 1300 nm. In this case, a peak of light intensity appears for every 14 to 15 light receiving sensors in the array light receiving unit 35 and light can be condensed in one light receiving sensor in the case of optimum adjustment. A high-order peak appears for every 18 to 19 light receiving sensors as a result of a Fourier transform being performed, resulting in a condition suitable for optical axis adjustment.

In the case where the value of the FSR of a transmission spectrum of the etalon filter 20 is small relative to the wavelength resolution of the array light receiving unit 35, it is difficult for the array light receiving unit 35 to recognize each peak of the transmission spectrum of the etalon filter. Therefore, the FSR is preferably ten times or more the wavelength resolution of the array light receiving unit 35. In the case where the value of the wavelength bandwidth of the array light receiving unit 35 is small relative to the FSR of a transmission spectrum of the etalon filter 20, adjustment can be performed only on a specific wavelength in the wavelength bandwidth of the array light receiving unit 35. Therefore, the wavelength bandwidth of the array light receiving unit 35 is preferably ten times or more the FSR of the transmission spectrum of the etalon filter 20. Furthermore, the FWHM of a transmission spectrum of the etalon filter 20 is smaller than the wavelength resolution of the array light receiving unit 35. Adjustment can be effectively performed as long as the conditions described above are satisfied.

1. A method of adjusting a spectroscopic imaging device comprising a collimating lens that collimates input light, a diffraction grating that receives light collimated by the collimating lens and outputs the light in different directions in accordance with a wavelength of the light, a condensing lens that condenses light outputted from the diffraction grating at different positions in accordance with a wavelength of the light, and an array light receiving unit that includes a plurality of light receiving sensors that are arranged in an array along a predetermined line and receives light condensed by the condensing lens by using one of the light receiving sensors, wherein
an etalon filter is disposed on an optical path of light inputted to the collimating lens, and
a relative arrangement relationship among the collimating lens, the diffraction grating, the condensing lens, and the array light receiving unit is adjusted so that, in a state where light that has passed through the etalon filter is inputted to the spectroscopic imaging device, a focal point of light of each wavelength condensed by the condensing lens is positioned on the predetermined line.

2. The method of adjusting a spectroscopic imaging device according to claim 1, wherein
a full width at half maximum of a transmission spectrum of the etalon filter is smaller than a wavelength resolution of the array light receiving unit.

3. The method of adjusting a spectroscopic imaging device according to claim 1, wherein
a free spectral range of the transmission spectrum of the etalon filter is ten times or more the wavelength resolution of the array light receiving unit, and
a wavelength bandwidth of light received by the array light receiving unit is ten times or more the free spectral range of the transmission spectrum of the etalon filter.

4. The method of adjusting a spectroscopic imaging device according to claim 1, wherein
a Fourier transform is performed on an intensity distribution of light received by the array light receiving unit and a spatial frequency distribution is obtained, and
the relative arrangement relationship among the collimating lens, the diffraction grating, the condensing lens, and the array light receiving unit is adjusted so that a value of a high-frequency component in the spatial frequency distribution is large.

5. The method of adjusting a spectroscopic imaging device according to claim 4, wherein
each of the light receiving sensors in the array light receiving unit is associated with a wavelength so that a relationship between a phase of a fundamental wave component in the spatial frequency distribution obtained by performing a Fourier transform and a wave number assigned to each of the light receiving sensors in the array light receiving unit is linear.

6. The method of adjusting a spectroscopic imaging device according to claim 1, wherein
the relative arrangement relationship among the collimating lens, the diffraction grating, the condensing lens, and the array light receiving unit is adjusted so that the sum total of α (α>1)-th power values of respective output values of the plurality of light receiving sensors of the array light receiving unit is large.

7. A spectroscopic imaging system comprising:
a collimating lens that collimates input light;
a diffraction grating that receives light collimated by the collimating lens and outputs the light in different directions in accordance with a wavelength of the light;
a condensing lens that condenses light outputted from the diffraction grating at different positions in accordance with a wavelength of the light;
an array light receiving unit that receives light condensed by the condensing lens by using one light receiving sensor among a plurality of light receiving sensors that are arranged in an array along a predetermined line;
an etalon filter that is provided so as to be disposed on or removed from an optical path of light inputted to the collimating lens as desired; and
adjustment means for adjusting a relative arrangement relationship among the collimating lens, the diffraction grating, the condensing lens, and the array light receiving unit.

8. The spectroscopic imaging system according to claim 7, wherein
a full width at half maximum of a transmission spectrum of the etalon filter is smaller than a wavelength resolution of the array light receiving unit.

9. The spectroscopic imaging system according to claim 7, wherein
a free spectral range of the transmission spectrum of the etalon filter is ten times or more the wavelength resolution of the array light receiving unit, and
a wavelength bandwidth of light received by the array light receiving unit is ten times or more the free spectral range of the transmission spectrum of the etalon filter.
